(19) United States
(12) Patent Application Publication
(10) Pub. No.: US 2006/0292267 A1
(43) Pub. Date: Dec. 28, 2006

(54) Process and formula for combining nutritional ingredients into edible vehicles by separating, utilizing and exploiting the optimum nutritional potency temperature of each nutritional element to provide an ultimate dietary health benefit to fauna when said edible vehicles are combined, prepared and consumed

(76) Inventor: Wayne Samuel Kurzeja, Barrington Hills, IL (US)

Correspondence Address: Wayne Samuel Kurzeja, 6 Fox Hunt Road, Barrington Hills, IL, 60010, US

(21) Appl. No.: 11/167,441

(22) Filed: Jun. 27, 2005

(51) Int. Cl. A23L 1/30

(52) U.S. Cl. 426/72

(57) ABSTRACT

The present invention provides a process and formula for combining nutritional ingredients into edible vehicles by separating, utilizing and exploiting the optimum nutritional potency temperature of each nutritional element to provide an ultimate dietary health benefit to fauna when said edible vehicles are combined, prepared and consumed.

### CROSS-REFERENCE TO RELATED APPLICATIONS

Not-Applicable

### STATEMENT REGARDING FEDERALLY SPONSORED RESEARCH OR DEVELOPMENT

Not-Applicable

### REFERENCE TO SEQUENCE LISTING, A TABLE, OR A COMPUTER PROGRAM LISTING COMPACT DISC APPENDIX

Not-Applicable

### BACKGROUND OF THE INVENTION

The present invention relates to improving the process of providing nutritional ingredients to a fauna via edible vehicles, and in particular, by separating, utilizing and exploiting the optimum nutritional potency temperature of each nutritional element.

There have been many prepared food products touting the dietary health benefits of added nutritional ingredients. Most boast of added vitamins, minerals and other various herbs and probiotis believed to be critical to the health and well being of fauna. Many products are specifically engineered to provide nutritional benefits for specific purposes. These specific purposes may vary from maintaining good health while dieting, improving health, providing necessary nutritional elements to fauna not willing or not able to provide for itself, or even to cure a condition believed to be caused by the lack of the provided nutritional element or elements. Thus the food industry strives to devise methods and means to deliver nutritional packages in a palatable and edible vehicle. Breads, cakes, cookies and gelatin desserts are some such edible vehicles.

The problem is intensified however by the recipes or methods by which these vehicles are prepared. Many, such as breads and gelatin desserts call for the nutritional elements to be subjected to intense heat or cold during preparation without regard to the optimum nutritional potency temperature of each nutritional element. The potency value of many nutritional elements are inhibited, reduced or even completely destroyed when subjected to the extreme temperatures during the process of preparing said edible vehicles.

Therefore there is a need to provide a method to assure that the nutritional potency of food products is not compromised during preparation.

### BRIEF SUMMARY OF THE INVENTION

The present invention provides a process and formula for combining nutritional ingredients into edible vehicles by separating, utilizing and exploiting the optimum nutritional potency temperature of each nutritional ingredient to provide an ultimate dietary health benefit to fauna when said edible vehicles are combined, prepared and consumed.

Thus the invention provides a process and method by which beneficial nutritional elements of a product are kept at the maximum potency to provide an ultimate dietary health benefit to fauna when said edible vehicles are combined, prepared and consumed by bifurcated or even trifurcated as to temperature requirements of each vitamin, mineral or any other nutritional ingredient.

### BRIEF DESCRIPTION OF THE DRAWINGS

FIG. 1. is an illustration and format of the various temperatures that may be used for each individual nutritional package of the present invention.

FIG. 2. depicts the various hot and cold nutritional packages combined in accordance with the format of the present invention in two different temperature-related levels.

FIG. 3. depicts the bifurcated hot and cold nutritional packages positioned for reintroduction via the second form of the embodiment of the invention.

### DETAILED DESCRIPTION OF THE INVENTION

The invention herein is based upon a widely accepted theory that the potency of vitamins, minerals as well as other types of nutritional substances are negatively affected by the extreme variations in temperature and further that the potency of certain substances may even be enhanced if placed within a specific measured temperature range.

“Edible delivery vehicle” as used herein means any final food product in which the nutritional package exists for consummation by fauna.

“Format” as used herein means the make-up and arrangement of a comestible product which is consumed by any fauna. The format of the present invention includes both a cold and hot bifurcated nutritional package and an edible delivery vehicle.

A “nutritional package” is simply a combination of nutritional ingredients which are selected for simultaneous delivery in the format as described herein. The nutritional ingredients are selected for their desired health benefits.

A “bifurcated nutritional package” is a combination of specially selected nutritional ingredients separated and grouped as to specific measured temperature ranges necessary to insure optimum nutritional potency.

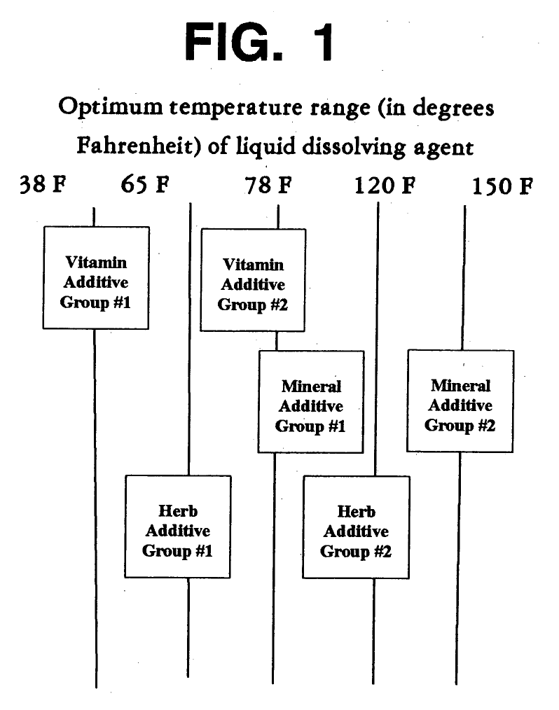

“Optimum nutritional potency temperature” as used herein (See Example FIG. 1) is the process of bifurcating a nutritional package according to temperature requirements necessary during preparation to retain ultimate nutritional potency thereby providing optimum dietary benefits.

“Nutritional ingredient” as used herein means a substance which has a real and/or perceived beneficial health benefits, and does not have long-term harmful biological effect(s) on the fauna. The beneficial health benefits can include, supplementing nutritional deficiencies in one's diet, and promoting weight loss. Nutritional ingredients which can be used for their beneficial health benefits, include, but are not limited to, vitamins, minerals, herbs, and probiotics.

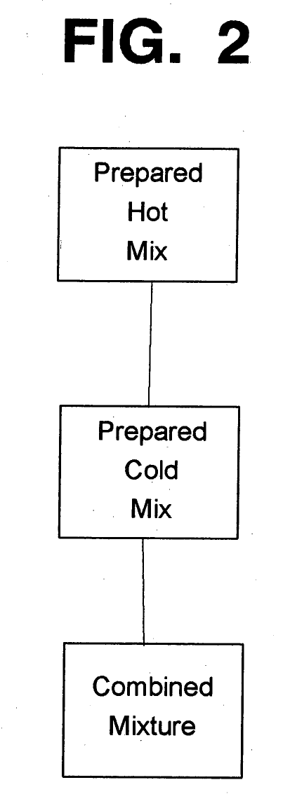

The embodiment of the invention is in at least two forms depending upon when and how the bifurcated nutritional package is re-united, i.e. during preparation of the edible delivery vehicle (at preparation) or after preparation of the edible delivery vehicle (at presentation). A clear description of the “at preparation” form would constitute reintroduction of the bifurcated nutritional package during the preparation of the edible delivery vehicle. Examples of this form (See Example FIG. 2) would be the preparation of dessert mixes such as pudding or gelatin. In the pudding example, two separate hot and cold mixes corresponding to the respective hot and cold bifurcated nutritional mixes are described as follows: The hot mix contains a blend consistent with ordinary dry pudding mix plus the bifurcated hot nutritional package. The corresponding cold mix consists of a blend consistent with ordinary instant dry pudding mix plus the bifurcated cold nutritional package. Both packages are prepared separately consistent with conventional methods of preparation, i.e. the hot pudding mix is mixed with milk and cooked to a boil while stirring, the instant pudding mix is simply blended with cold milk and stirred. After allowing the hot mix to cool to room temperature both mixes are blended together and left in a refrigerator to cool and properly solidify. Similarly the gelatin mix consists of two separate mixes. The hot mix is comprised of a blend of a conventional powered and flavored gelatin mix blended with the bifurcated nutritional hot mix package. The cold mix package is a blend of a corresponding flavored powered drink mix blended with the bifurcated nutritional package. Again, both are prepared in a manor consistent with conventional methods of preparation, i.e. the gelatin mix is blended with water and brought to a boil while the drink mix is simply blended with cold water and stirred. When the hot mix reaches room temperature both mixes are combined and placed in a refrigerator to properly solidify.

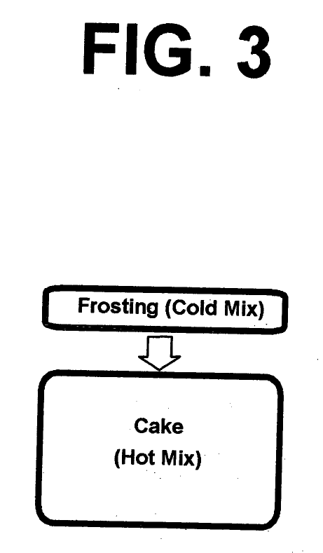

A second form of the embodiment of the invention (See Example FIG. 3) calls for the reintroduction of the bifurcated hot and cold nutritional packages at presentation rather than at preparation. Examples of this form of the invention would be a cake with frosting or cookies with sweetened powder or “sprinkles” on the cookies. In this method the bifurcated hot mix nutritional package would be contained in the cake mix or the cookie dough and the bifurcated cold mix nutritional package would be contained in the frosting or the “sprinkles” to be placed upon the cake or cookies after baking and cooling.

Vitamins are important nutrients in the diet of any fauna. A vitamin is any organic substance which is typically essential for the normal growth and activity of fauna. Vitamins are fat-soluble or water-soluble. The vitamin can be in the form of a solid or a liquid. The vitamins can be obtained from a multivitamin tablet, such as for example, Centrum.RTM. manufactured by Wyeth. The vitamin can be any vitamin. Examples of vitamins include, but are not limited to, vitamin A (retinol), B1 (thiamine), B2 (riboflavin), B complex, B6 (pyridoxine), B12 (cobalamin), C (ascorbic acid), D (cholecalciferol), E (tocopherol), F (linoleic acid), G, H (biotin), and K, and choline, folic acid, inositol, niacin, pantothenic acid, and para-aminobenzoic acid.

The specific health benefits of a particular vitamin are known to those skilled in the art. The nutritional package can contain any combination of vitamins. The amounts and combination of vitamins in a nutritional package can be selected for their known and/or desired benefits to fauna in general and/or tailored to a particular individual or patient. For example, if the desired health benefit is for weight loss, the nutritional package can contain Vitamin B6.

Minerals are naturally occurring inorganic substances which are typically essential to the nutrition of fauna. The mineral can be any mineral. Examples of minerals include, but are not limited to, boron, calcium, chromium, copper, iron, magnesium, manganese, molybdenum, nickel, phosphorus, selenium, silicon, tin, vanadium, and zinc. Substances containing minerals, such as, for example, a multivitamin tablet containing minerals, can be used as the source of the mineral.

The specific health benefits of a particular mineral are known to those skilled in the art. The nutritional package can contain any combination of minerals. The amounts and combination of minerals in the nutritional package can be selected for their known and/or desired benefits to fauna in general and/or tailored to a particular individual or patient. For example, if the nutritional package is for weight loss, the nutritional package can contain the mineral vanadium.

Herbs are plants which are typically used for their medicinal properties. The active medicinal component can be from any part of the plant (e.g., stem, leaves, flowers, seeds, and roots). The medicinal component of the herb can be extracted and purified into a liquid or solid form. The extraction and purification of the active, medicinal component of an herb are known to those skilled in the art. It is not necessary to extract and purify the active medicinal component of the herb. For example, fresh or dried herb can be finely chopped and added to the nutritional package. The herb can be any herb. Examples of herbs include, but are not limited to, alfalfa, althea root, asparagus root, chamomile, garlic, ginger, ginseng, echinacea, ginkgo biloba, valerian root, kelp, Saint John's Wart, yohimbe, and yucca root.

The specific health benefits of a particular herb are known to those skilled in the art. The nutritional package can contain any combination of herbs. The amounts and combination of herbs in the nutritional package can be selected for their known and/or desired benefits to fauna in general and/or tailored to a particular individual/patient. For example, if the nutritional package is for weight loss, the nutritional package can contain kelp.

Probiotic, as used herein, is typically a microbial supplement which beneficially improves the microbial balance of an individual. For example, probiotics can aid in digestion and help prevent illness by promoting the growth of good bacteria in the digestive tract of the individual. The probiotic can be any probiotic. Examples of probiotics include, but are not limited to Bifidobacteria and Lactobacillus.

The specific health benefits of a particular probiotic are known to those skilled in the art. The nutritional package can contain any combination of probiotics. The amount and combination of probiotics in the nutritional package can be selected for their known and/or desired benefits to fauna in general and/or tailored to a particular individual or patient. For example, if the nutritional package is for treating weight loss, the nutritional package can contain the probiotic Lactobacillus acidophilus.

The nutritional ingredients described above can be use alone, or in combination with one another. For example, the nutritional package can contain vitamin(s); vitamin(s) and mineral(s); vitamin(s), mineral(s) and herb(s); vitamin(s), mineral(s), herb(s), and probiotic(s); vitamin(s), herb(s), and probiotic(s); etc. The combination of nutritional ingredients to include in a nutritional package depends on the desired health benefit.

If, for example, the desired health benefit is to supplement one's diet, the combination of nutritional ingredients for the nutritional package can be a mixture of vitamins and minerals. Description of possible bifurcated nutritional formula for weight loss could be as follows: Cold mix formula may contain the following: vitamin A (Palmitate), vitamin A (Beta Carotene), vitamin B1 (Thiamine HCI), vitamin B 2 (Riboflavin), vitamin B6 (Pyridoxine HCI), vitamin B12 (Cyanocobalamin), vitamin C (Ascorbic Acid), vitamin C (Calcium Ascorbate), vitamin D (Ergocalciferol), vitamin E (Tocopheryl Acetate), vitamin K (Phytonadione), biotin, chromium (Chromium Amino Acid Chelate), copper (Cupric Amino Acid Chelate) and folic acid, niacin, pantotenic acid, plus naturally occurring amino acids. And the corresponding hot mix formula may contain the following: boron, calcium, chloride, chromium picolinate (100 mcg per serving), iodine, iron, maganese, magnesium, nickel, phosphorus, potassium, selenium and zinc.

If the nutritional package contains vitamins and minerals, the nutritional package and format is formulated such that the format delivers, per serving, not less than about 5% of the daily value, as defined by the National Academy of Sciences (NAS), of each of the vitamins and minerals present in the nutritional package, preferably not less than about 7%, and more preferably not less than about 9% of the daily value. The maximum amount is not greater than about 100% of the daily value, preferably not greater than about 50%, and more preferably not greater than about 40% of the daily value. In a preferred embodiment, each serving of the format contains approximately 10% daily value of each of the vitamins and minerals present in the nutritional package of the format.

In addition to the components set forth above, the format of the present invention can further contain other components such as preservative(s), acid(s), sweetener(s), flavor(s) and/or color(s).

The preservative can be any preservative suitable for fauna consumption. Examples of preservatives include benzoic acid, sorbic acid, ascorbic acid, and salts thereof, such as potassium sorbate, sodium benzoate, and EDTA, and combinations thereof. If the format contains preservatives, the preservative is in an amount not less than about 0.05% by weight based on the total weight of all the components of the format, and preferably not less than about 0.07% by weight based on the total weight of all the components of the format. The preservative is in an amount not greater than about 0.1% by weight based on the total weight of all the components of the format, and preferably not greater than about 0.095% by weight based on the total weight of all the components of the format.

For example, the preservatives sodium benzoate and potassium sorbate can be used in combination in a total amount of about 0.094% by weight based on the total weight of all the components of the format.

The acid (e.g., taste modifiers) can be any acid suitable for fauna consumption. Acids include organic acids, inorganic acids, and combinations thereof. Examples of organic acids include citric acid, fumaric acid, tartaric acid, and malaic acid and salts thereof, such as sodium citrate. An example of an inorganic acid includes phosphoric acid and salts thereof. If the format contains acids, the acid is in an amount not less than about 0.1% by weight based on the total weight of all the components of the format, preferably not less than about 0.5%, and more preferably not less than about 0.9% by weight based on the total weight of all the components of the format. The acid is in an amount not greater than about 2.0% by weight based on the total weight of all the components of the format, preferably not greater than about 1.7%, and more preferably not greater than about 1.5% by weight based on the total weight of all the components of the format.

For example, the acids fumaric acid and sodium citrate can be used in combination in a total amount of about 0.94% by weight based on the total weight of all the components of the format.

The sweetener useful in the present invention includes natural sweeteners. Examples of natural sweeteners include maltose, sucrose, glucose, sorbitol, and dextrose.

If the format contains natural sweeteners, the natural sweetener is in an amount not less than about 5% by weight based on the total weight of all the components of the format, preferably not less than about 10% by weight, and more preferably not less than about 15% by weight based on the total weight of the format. The natural sweetener is in an amount not greater than about 50% by weight based on the total weight of all the components of the format, preferably not greater than about 40%, and more preferably not greater than about 30% by weight based on the total weight of all the components of the format. For example, a format can contain about 23% natural sweeteners.

The sweeteners can also include artificial sweeteners. Examples of artificial sweeteners include aspartame, acesulfame, cyclamate, saccharine, and saccharine salts. Natural sweeteners can be used in combination with artificial sweeteners to, for example, mask the after-taste of the artificial sweetener.

The flavor can be any flavor typically used in the food and/or nutraceutical industry. Flavors include artificial flavors, natural flavors, and combination thereof. Examples of flavors include various fruit flavors, such as, for example, cherry, black raspberry, strawberry, lemon, orange, grape, pineapple.

If the format contains flavors, the amount of flavor useful in the format of the present invention depends on the nature (e.g., strength) of the flavor. Typically, a small amount of flavor can be used, such as from about 0.01% to about 5% based on the total weight of all the components of the format.

The color can be any color typically used in the food and/or nutraceutical industry. Examples of colors include red #40 and blue #1. If the format contains colors, typically a small amount of color can be used, such as from about 0.0001% to about 2% based on the total weight of all the components of the format.

As stated above, the nutritional ingredients to include in the format of the present invention depends on the desired use of the composition. It is known to those skilled in the art which nutritional ingredient(s) are beneficial for a desired health benefit. The nutritional package can be formulated, for example, to be used as a nutritional supplement to supplement one's diet or to enhance one's health, such as weight loss.

Any fauna can consume the format of the present invention. The fauna can be any fauna which would benefit from ingesting a format containing a desired nutritional package. The fauna may desire to enhance their health by, for example, losing weight. Ingesting the format results in delivery of a desired nutritional package to the fauna.

In another embodiment, the fauna can be treated with a nutritional package containing at least two bifurcated nutritional ingredients selected for its desired health benefit. The treatment of a fauna includes administering to the fauna, a nutritional package in accordance with a regimen designed to provide a desired health benefit.

The regimen can be any regimen which beneficially results in a desired health benefit for the fauna, and can result from a prescription by a physician to obtain a desired health benefit.

The regimen can include a time-related dosage level for administration of the nutritional package. For example, a smaller dose 18 could be required every four (4) hours, while a larger dose 20 could be required every six (6) hours. The dosage level is any dosage level which results in a desired health effect of a nutritional package, without long-term harmful biological effect(s) on the fauna.

The regimen can also be based on frequency of administration, rather than on a strict time schedule. For example, the nutritional package can be formulated for administration of at least once a day, three times a day, etc. The regimen can also be based on time and/or frequency of administration.

The desired health benefit of a nutritional package can be weight loss. The nutritional package for weight loss can be formulated such that the regimen for administration of the package is ingested at least once a day. For example, the fauna who desires to lose weight, can ingest the formulated package once a day for two weeks or until the target weight is achieved.

In a preferred embodiment, the regimen for a nutritional package for weight loss can be formulated for ingestion at least three times a day for three days. Without being bound by theory, it is believed that a fauna treated with a nutritional package for weight loss and following a regimen of three times a day for three days results in a reduction in weight of at least two pounds, preferably at least six pound, and more preferably at least twelve pounds.

1- An improved process and format for combining edible vehicles with nutritional ingredients comprising: (a) Any edible substance prepared as a formulate mixture for the purpose of combining with at least one other formulate mixture which together create any edible vehicle palatably acceptable to most fauna and; (b) At least two separate nutritional elements wherein the nutritional elements will be combined with said edible vehicles.

2- A protocol for combining edible vehicles balancing the appropriate temperature necessary for preparation of the combined edible vehicles against the temperature range necessary to insure optimum potency of the nutritional elements of the final product.

3- A format according to claims 1 and 2, wherein said health benefit is weight loss.

4- A format according to claims 1 and 2, wherein said format provides a nutritional supplement.

5- A format according to claims 1 and 2, wherein said format provides a therapeutic dosage.
